(19) United States
(12) Patent Application Publication
(10) Pub. No.: US 2006/0201974 A1
(43) Pub. Date: Sep. 14, 2006

(54) Condiment cartridge

(75) Inventor: Christopher John Schuster, Batavia, OH (US)

Correspondence Address: WOOD, HERRON & EVANS, LLP, 2700 CAREW TOWER, 441 VINE STREET, CINCINNATI, OH, 45202, US

(73) Assignee: Sure Shake, LLC

(21) Appl. No.: 11/076,837

(22) Filed: Mar. 10, 2005

(51) Int. Cl. B67D 5/06; B67D 1/07

(52) U.S. Cl. 222/183; 222/565; 222/78; 222/192; 222/113; 222/151

(57) ABSTRACT

A condiment shaker includes an inner container that may be inserted into an outer container. The inner container contains the condiment and may be removed and replaced during refilling. The inner container may include a base to lend support to the containers when assembled. Where desired, a handle grip, flip top lid and prongs for dislodging material in the container may be used to facilitate pouring of the condiment.

### FIELD OF THE INVENTION

The present invention relates to containers for dispensing materials stored therewithin, and more particularly, to shakers for condiments.

### BACKGROUND OF THE INVENTION

Salt and other condiment shakers are commonly used to store and dispense salt, pepper or other spices. The shakers generally consist of a hollow container having a screw or push-on top. The top is removed while the shaker is filled with condiment. The top includes several openings through which the contained condiment can be shaken through once the top is secured.

Refilling shakers can be problematic for some people. For instance, a waitress at a restaurant may spill salt while attempting to pour it into a relatively tiny hole located at the bottom of a shaker. In some instances, the act of opening the hole to refill the shaker can be a tedious task that can also result in spills and frustration.

Once filled, condiments in the shaker tend to absorb moisture from outside air that enters the shaker. Such moisture often imparts undesirable qualities to the stored condiment, and can among other problems, clog dispensing openings. Protective covers used to minimize moisture can be difficult and inconvenient to manipulate. For instance, caps having pins to clean the dispensing holes must be screwed onto a shaker to remove debris. This requirement is inconvenient for the user and prone to spills.

There is therefore a need for an improved condiment shaker.

### SUMMARY OF THE INVENTION

The present invention provides an apparatus comprising an outer container and an inner container configured for holding and dispensing condiment material. At least a portion of the inner container is configured to fit within the outer container, and the inner container includes an opening configured to allow the through-flow of the material while at least a portion of the inner container is within the outer container.

In one embodiment, the inner container includes a base configured to stabilize the outer container when the inner container is positioned within the outer container. In such a case, the outer container includes an aperture configured to allow the through-flow of the material from the opening of the inner container. As such, the inner container may be positioned inside the outer container through a second aperture in the outer container. Where desired, the inner container may screw into mating threads positioned along the inside surface of the outer container. The inner container may alternatively snap into the outer container, or may snugly fit or otherwise reside within the outer container. As such, the inner container and the base may cooperate to stabilize the outer container, e.g., hold the outer container upright.

Another feature of the invention allows the inner container to function as an insertable refill cartridge. For instance, the inner container may be positioned inside the outer container. When a seal (if present) of the inner container is broken, the condiment material may flow out of the resultant opening in the inner container. In one application, the hole in the seal may be made by a projection from a lid biased towards a top surface of the outer or inner containers. The projection may be positioned on an underside surface of a flip top lid. The inner container may further include an extension that extends out from a length of the inner container and rests on a mating surface of the outer container. Such an extension may include a lip that rests on a top surface of the outer container when the inner container is inserted into the outer container.

The base and/or inner container features of the present invention enable appealing outer containers that would otherwise be unstable or impractical to implement. For instance, an outer container may include a figurine that might otherwise be incapable of standing upright without the base. Such features of the present invention also allow materials to be used in constructing the outer container that are not conventionally used in salt shakers because the construction material is not sturdy enough or the salt could contaminate or otherwise require the construction material to be cleaned. For instance, the containment of the condiment provided by the inner container may allow for the incorporation of electronics in the outer container. Circuitry incorporated into the outer container may include lights and/or audio from a speaker for added affect. Another feature may include an automated moveable part, such as an arm of a figurine comprising the outer container.

Another aspect of the invention may include a flip top lid biased towards a top surface of the container. The lid may include a projection positioned on an underside surface of the flip top lid that is configured to travel through the opening in the container top. A grip handle may be attached to the container so that a user may hold the grip handle and operate the flip top lid using the thumb of the same hand used to grip the handle. Where desired, the container top may be slid over the top portion of the container. The container top may alternatively be manufactured integrally with the container.

Another aspect of the invention includes a hollow container configured to hold and dispense a condiment, wherein the apparatus includes a prong configured to mechanically rotate about an axis within the hollow container. The rotation of the prong may agitate the material, for instance, to loosen material that becomes stuck to the inside of the container or other material. To this end, the apparatus may include gears and other mechanical structures to accomplish rotation of the prong.

These and other objects and advantages of the present invention will become more readily apparent during the following detailed description taken in conjunction with the drawings herein.

### BRIEF DESCRIPTION OF THE DRAWINGS

FIG. 1 shows an outer container having a flip top lid and an inner container positioned inside the outer container.

FIG. 2 shows disassembled inner and outer containers similar to those of FIG. 1.

FIG. 3 shows the flip top lid of FIG. 2 with projections that travel through openings in the top surfaces of the outer and inner containers.

FIG. 4 shows another embodiment having inner and outer containers.

FIG. 5 shows the flip top lid of the container combination of FIG. 4.

FIG. 6 shows a condiment container having a plurality of prongs configured to rotate within the container.

FIG. 7 shows a cross-sectional view of the container of FIG. 6 taken along line 7-7.

FIG. 8 shows a condiment shaker having a flip top lid configured to slide over and mate with a hollow container portion that is configured to hold condiment material.

FIG. 9 shows a condiment shaker having a flip top lid.

FIG. 10 shows a cross-sectional view of the condiment shaker of FIG. 9.

FIG. 11 shows a cross-sectional view of the condiment shaker of FIG. 9 with the flip top lid locked in the open position.

FIG. 12 shows another cross-sectional view of the condiment shaker of FIG. 9 with the flip top lid locked in the closed position.

FIG. 13 shows a disassembled condiment shaker comprising a flip top lid, an insertable inner cartridge container, and an outer container.

FIG. 14 shows the plurality of inner containers attached for storage and transport.

FIG. 15 shows a condiment shaker having a grip handle.

FIG. 16 shows a user holding the condiment shaker of FIG. 15.

### DETAILED DESCRIPTION OF THE INVENTION

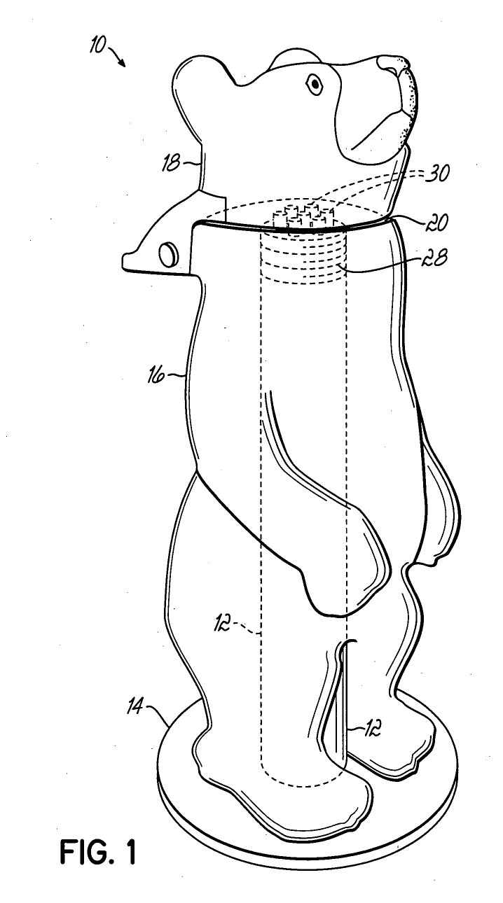

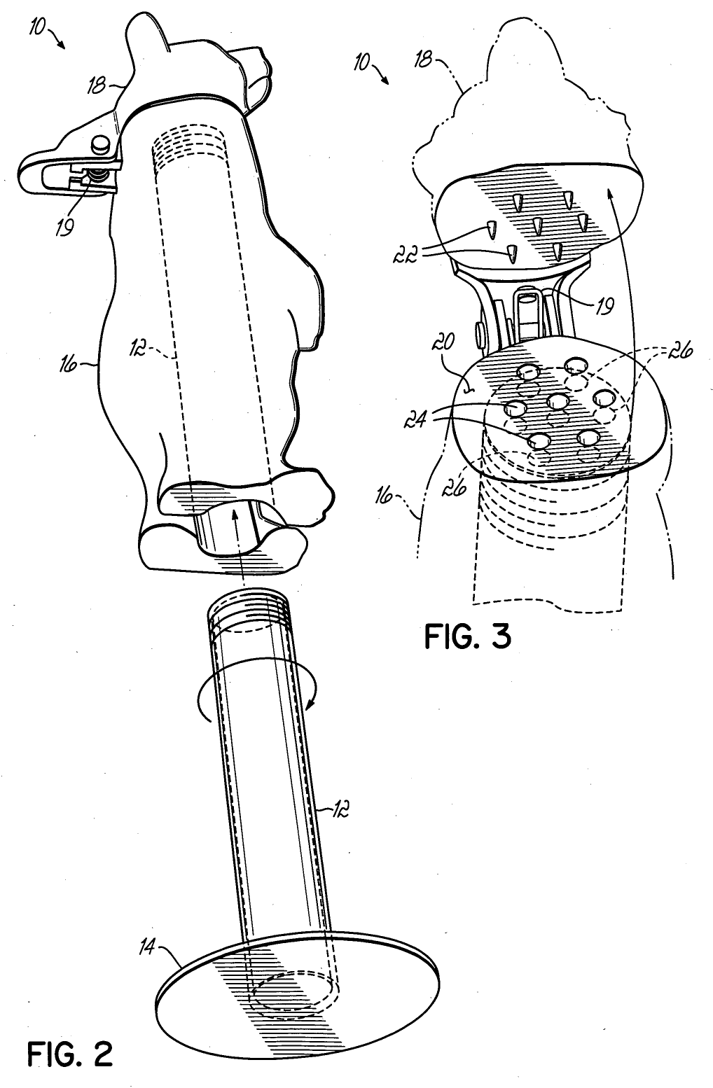

FIG. 1 shows an improved condiment shaker 10 that includes an inner container 12 comprising a base 14. The inner container 12 is configured to slide or otherwise fit within an outer container 16, as shown in FIG. 1. The inner container 12 may be full of condiment material, e.g., salt. The inner container 12 may be removed, e.g., by snapping into or by screwing into the outer container 16, as shown in the embodiment of FIG. 2. The base 14 functions in part to stabilize the containers 12, 16. That is, the outside container 16 may rest on or be held in place by the base and/or inner container 12. While a base 14 is shown in FIG. 1, one skilled in the art will appreciate that an inner container need not have a base.

The condiment shaker 10 shown in FIG. 1 includes a flip top lid 18 that is biased towards a top surface 20 of the outer container. That is, the flip top lid 18 is generally biased closed. While one skilled in the art will appreciate that other biasing mechanisms may be used in accordance with the principals of the present invention, a spring 19 is used in the embodiment of FIG. 2.

As shown in the embodiment of FIG. 3, the flip top lid 18 may include projections 22 that function, in part, to clear apertures 24 and openings 26, respectively, in either or both containers 16, 12. Such projections are disclosed in U.S. patent application Ser. No. 10/922,295, which was filed on Aug. 19, 2004 by Christopher John Schuster et al., is entitled “CONDIMENT SHAKER,” and is incorporated by reference herein in its entirety.

The condiment material inside inner container 12 may be covered with a container cover 28 having openings 30 to allow the condiment material to be dispensed from the inner container 12. During refilling, the cover 28 may be taken off to allow the user to refill the inner container 12. During such a refill operation, the inner container 12 is removed from the outer container 16 for ease of access. The cover 28 shown in FIG. 1 includes openings 30 that comprise raised or contoured surfaces. Where desired, the inner container 12 may include no cover, or alternatively, a break or tear-away cover. In one embodiment shown in FIG. 3, the projections 22 of the lid 18 may be used to puncture a disposable seal 32 to create openings 26.

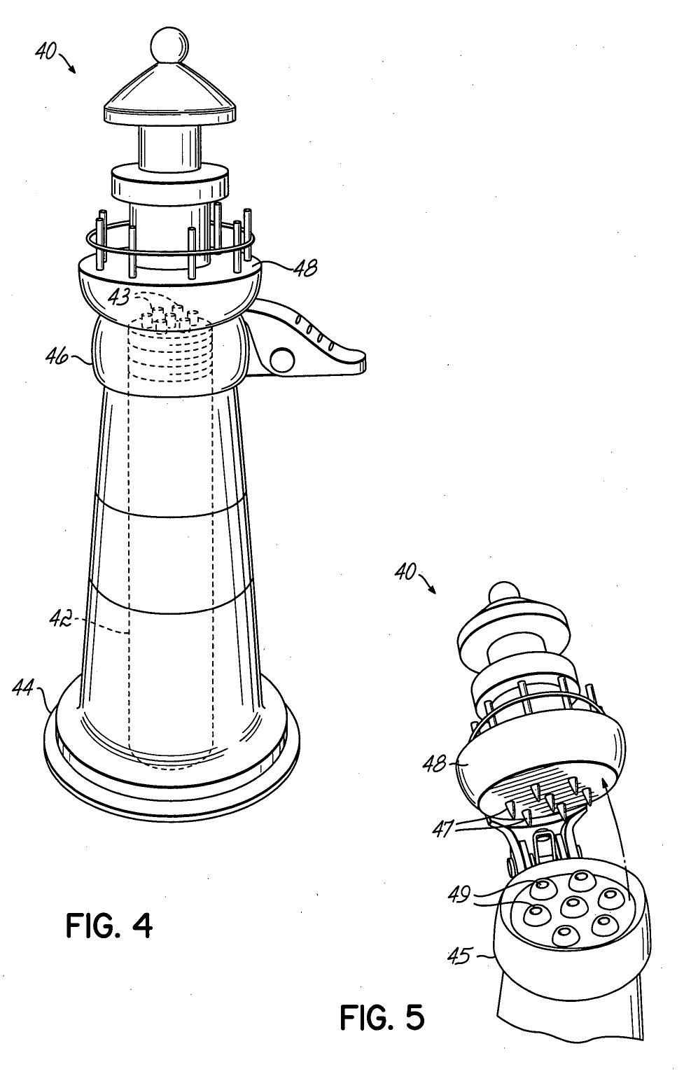

FIG. 4 shows another embodiment of a condiment shaker 40 that includes an insertable inner container 42 having a base 44. The inner container 42 rests inside an outer container 46 having a flip top lid 48. The base 44 and other physical features of the inner container 42 thus cooperate to stabilize, e.g., to hold upright, the outer container 46. Among other benefits, the inner container 42 protects the outer container 46 from corrosion, soiling and other adverse effects that could otherwise result from exposure to the material contained in the inner container 42.

FIG. 5 shows in greater detail the flip top lid of the condiment shaker 40 of FIG. 4. The cover 47 of the lid includes raised apertures 49 to facilitate the flow of material from the inner container 42 and the outer container 46. When the flip top lid 48 is in a closed position as shown in FIG. 3, the projections 47 function, in part, to clear the apertures 49 of any material that might otherwise clog the apertures 49. When in an open position, as shown in FIG. 5, condiment or other material may be shaken out of the shaker 40 through the openings 43 in the inner container 42 and the apertures 49 in the container top 45.

The anti-clogging feature of the projections 47 enables smaller apertures 49 because there will be less incidences of clogging. This enables more control of the amount of material that is dispensed by the condiment shaker 40. This feature further enables finer granularity of the material, such as a finer salt.

These features, alone and in combination, act to keep moisture and other contaminants from the material. In one embodiment, the condiment shaker 40 is water resistant and/or waterproof. Such a feature may have particular application in outdoor settings, e.g., backpacking, camping, military manoeuvres, etc.

In addition to keeping moisture out of the contents of the container 42, the projections 47, lid 48 and other physical features of the invention additional function to keep the material inside the shaker 40. That is, an embodiment of the present invention is also spill proof.

The contoured surface of the container top 45 is raised circumferentially around the apertures 49. Though not shown in FIG. 5, corresponding recesses inside an inner lid surface of the flip top lid 48 may be aligned and otherwise mate with the contoured surface of the top 45 to form a seal. The lid may be constructed from plastic, metal, rubber or any synthetic material, as may be the projections 47 and rest of the container 40.

The projections 47, themselves, may function to seal the apertures 49 and openings 43 of the inner container 42 when the flip top lid is in a closed position, as shown in FIG. 4. Moreover, a seal may be included within the flip top lid 48 functions to keep air and moisture away from the material within the shaker 40. One skilled in the art will appreciate that the seal may comprise any material configured to prevent dispersion of moisture, but is typically made of rubber.

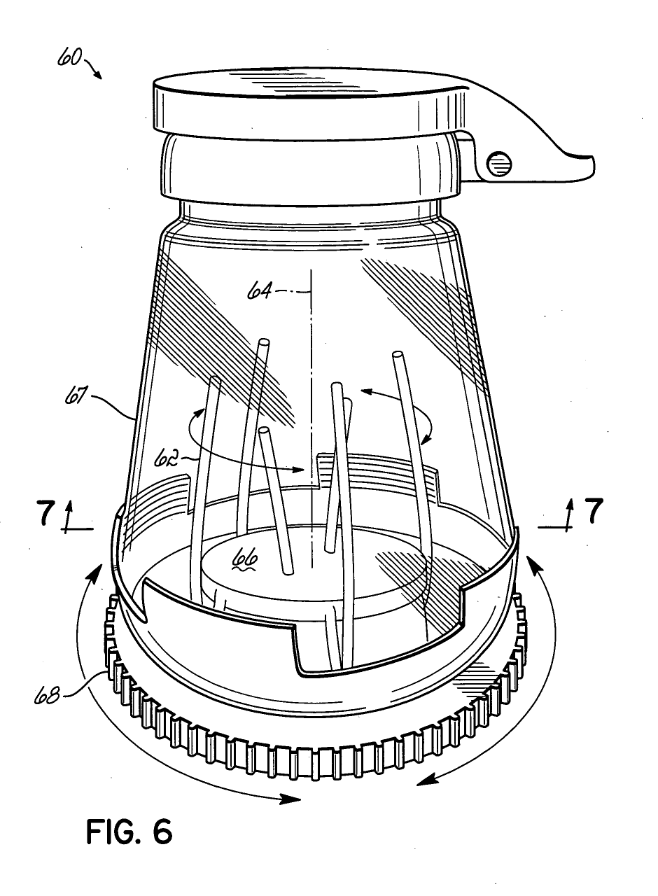

FIG. 6 shows a condiment shaker 60 having a plurality of prongs 62 configured to rotate about an axis 64. The prongs 62 are shown attached to a structure 66 that may comprise or may otherwise communicate with a gear. The gear structure 66 is configured to rotate the prongs 62 in response to movement of the attached structure 66. In one embodiment, the structure 66 may be moved when a user grips the shaker 60 along a ridged bottom surface 68 to cause the structure 66 and associated prongs 62 to move. Movement of the prongs 62 may help break up, grind, and/or mix material within the condiment shaker 60, such as cheese or sugar, for instance.

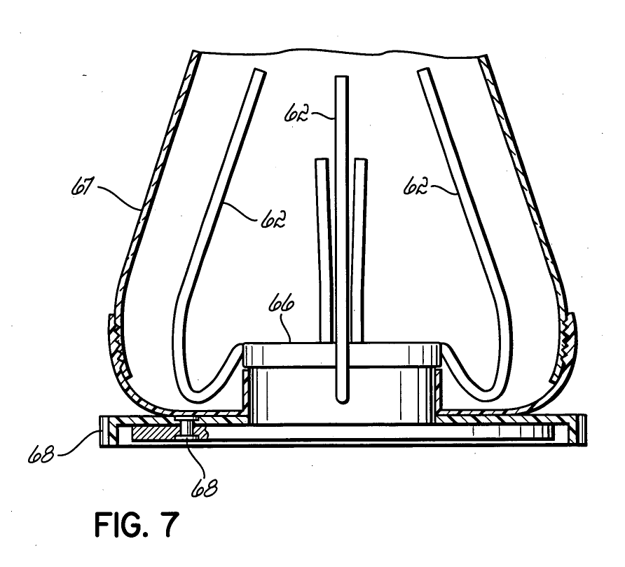

FIG. 7 shows a cross-sectional view of the condiment shaker 60 shown in FIG. 6 taken along line 7-7. A rivet 69 may be used to attach the structure 66, which is used to communicate rotational forces to the prongs 66, to the shaker container 67.

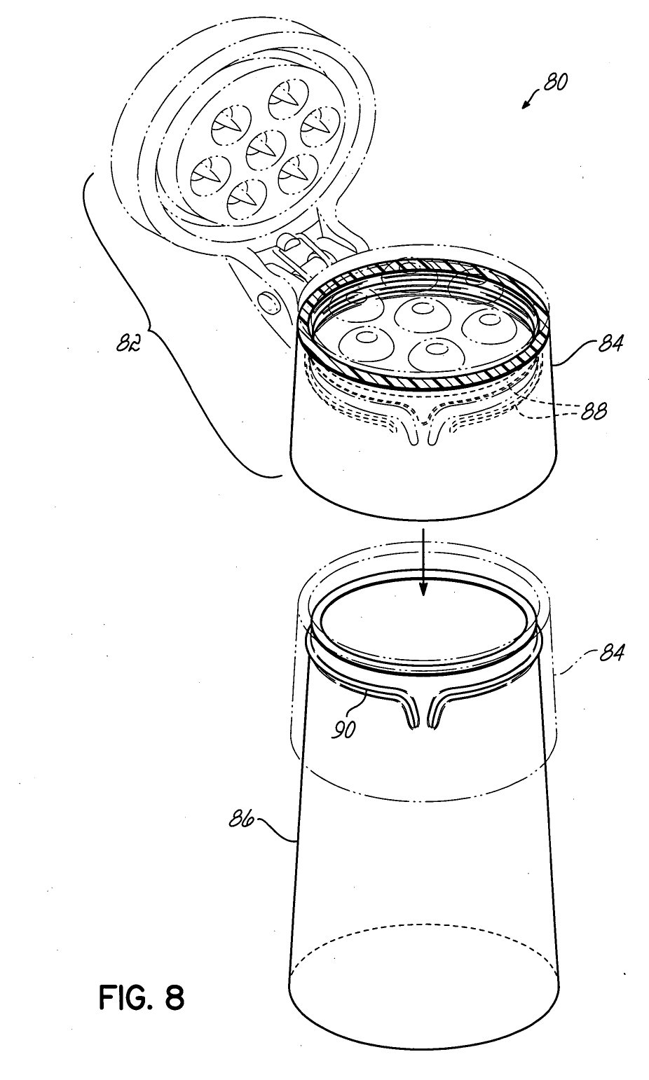

FIG. 8 shows a condiment shaker 80 having a flip top lid 82 that includes a cover portion 84. The cover portion 84 is configured to slide over and attach to a base portion 86 of the condiment shaker. To this end, contoured or angled threads 88 inside the cover 84 cooperate with mating threads 90 on the outside surface of the base portion 86 to secure the cover 84. In one embodiment, the threads comprise rubber, plastic or another flexible material that allows the threads to slide over one another. This feature facilitates ease of lid 82 removal and replacement, while providing a secure lid fastener.

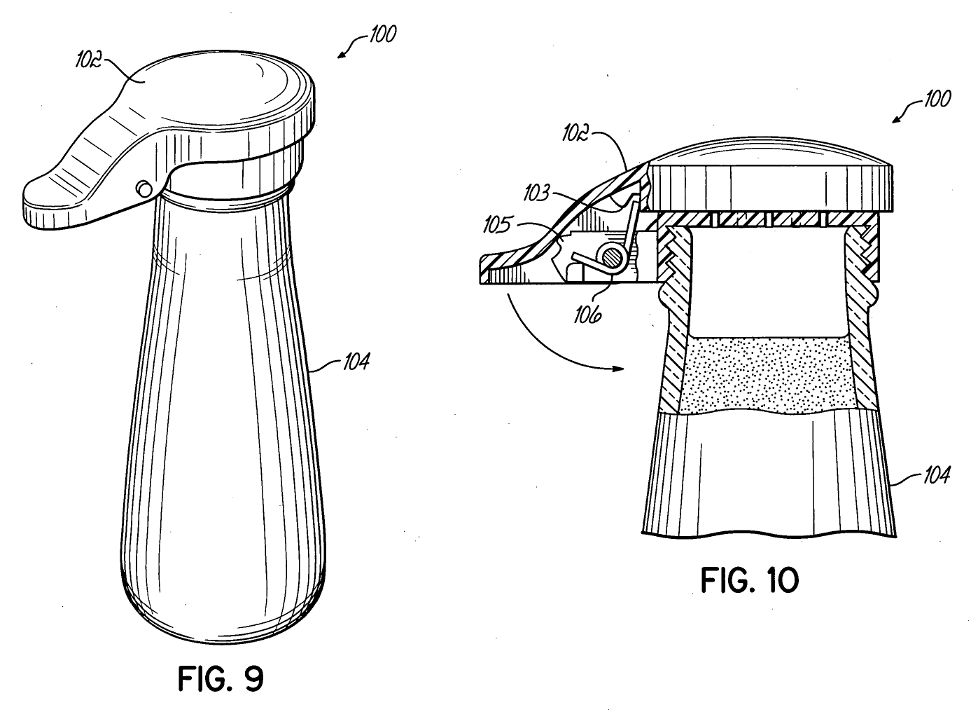

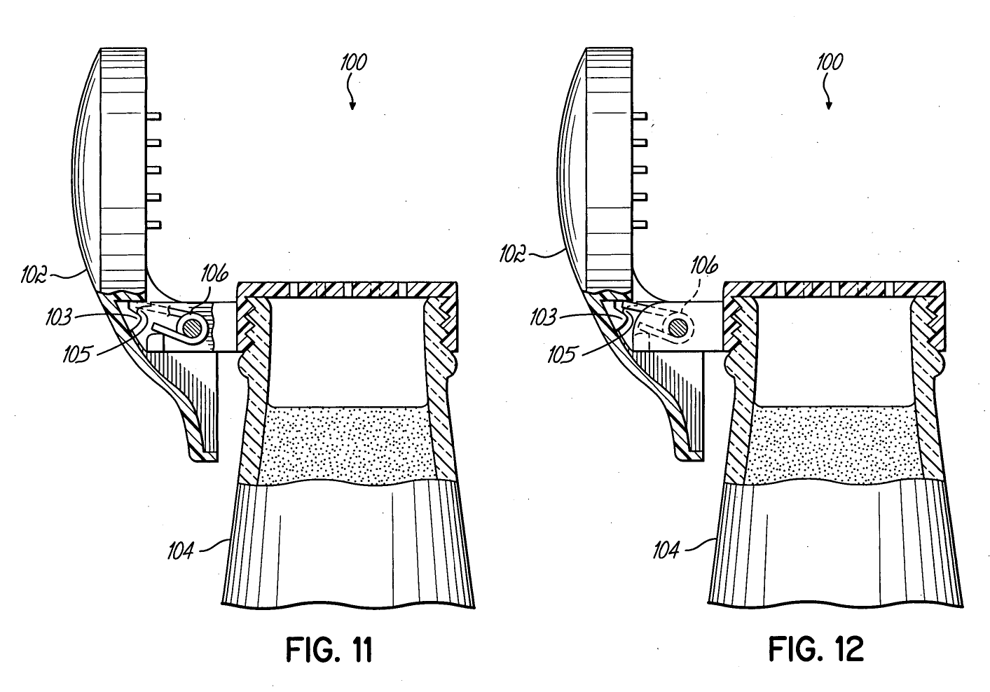

FIG. 9 shows a condiment shaker 100 having a flip top lid 102 and a hollow container 104. As shown in FIGS. 10-12, the lid 102 includes a spring 106, and is configured to be locked into place by corresponding catches 103 and 105. The catches 103 and 105 cooperate when the lid 102 is flipped open such that the lid 102 remains in a locked and open position. While the locking mechanism FIGS. 10-12 may have particular application in certain embodiments that are consistent with the principles of the invention, one skilled in the art will appreciate that other fasteners useful in holding the lid of another embodiment may alternatively be employed, such as those fasteners including latches or magnets, as are known in the art.

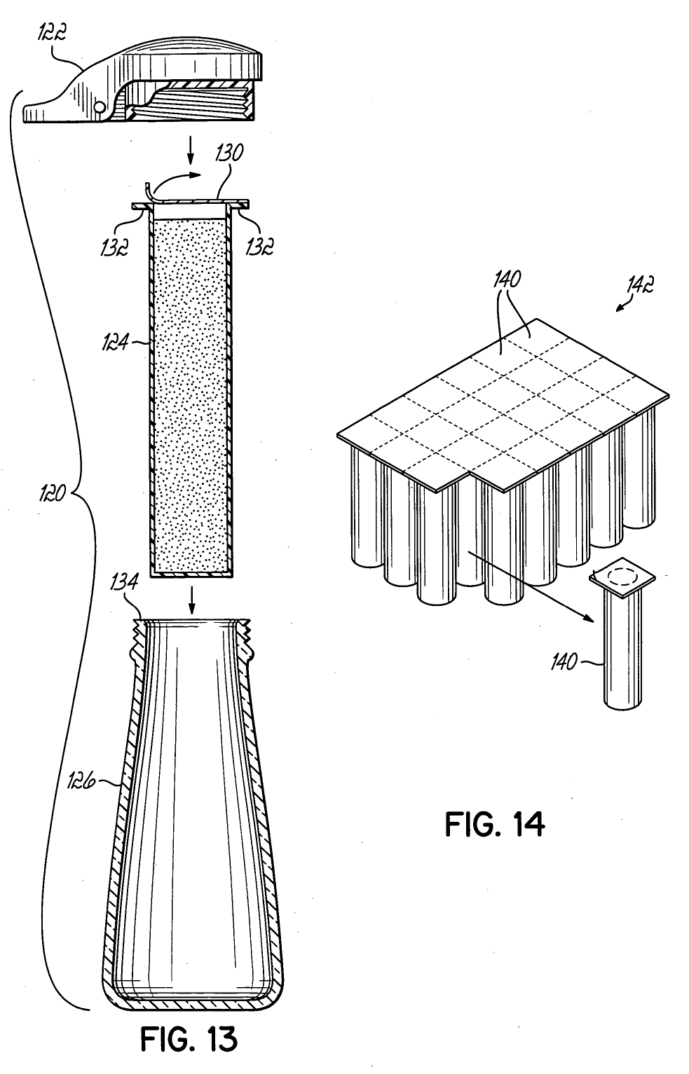

FIG. 13 shows a condiment shaker 120 having a flip top lid 122 and an inner container 124 configured to fit inside an outer container 126. The inner container 124 contains condiment material 128 and may be sealed with a removable seal 130. Inner container 124 includes extensions 132, or lips, that extend away from the length of the inner container 124 and rest on a concentric, upper surface 134 of the outer container 126. One skilled in the art will appreciate that another suitable extension may be located along an intermediate surface along the length of the inner container 124. As shown in FIG. 13, the seal 130 may be peeled off, or in another embodiment, the seal 130 may be punctured or otherwise broken away to allow access to the condiment material 128.

When replacing the inner container 124, a user may unscrew or otherwise remove the flip top lid 122 that had secured the inner container 124 in place. The user may then remove the inner container 124 and replace it with a new inner container once the material 128 in the first container has been used. A user consequently does not have to pour salt or other material 128 when refilling the condiment shaker 120. This feature further helps prevent stagnant salt that can result at the bottom of a shaker using conventional refilling techniques.

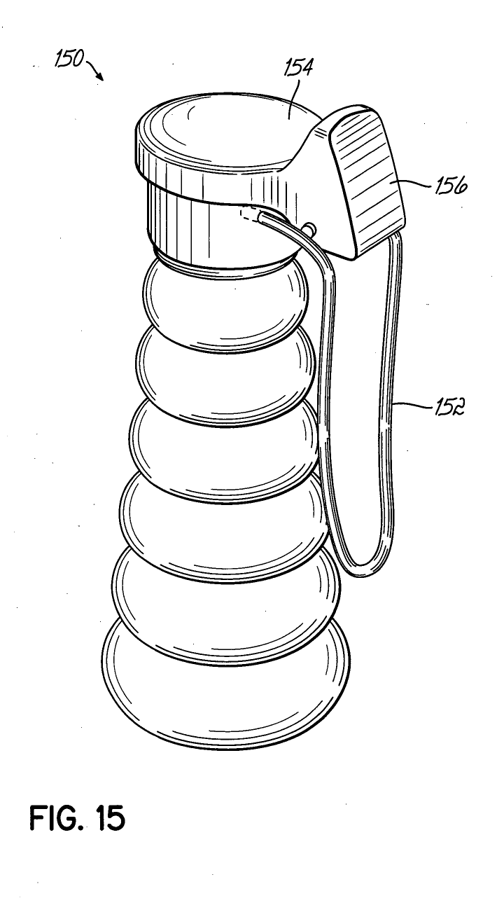

FIG. 14 shows a plurality of inner containers 140 attached along their sides as a unit 142. A user may thus store, transport or break away sections of the unit 142 as needed.

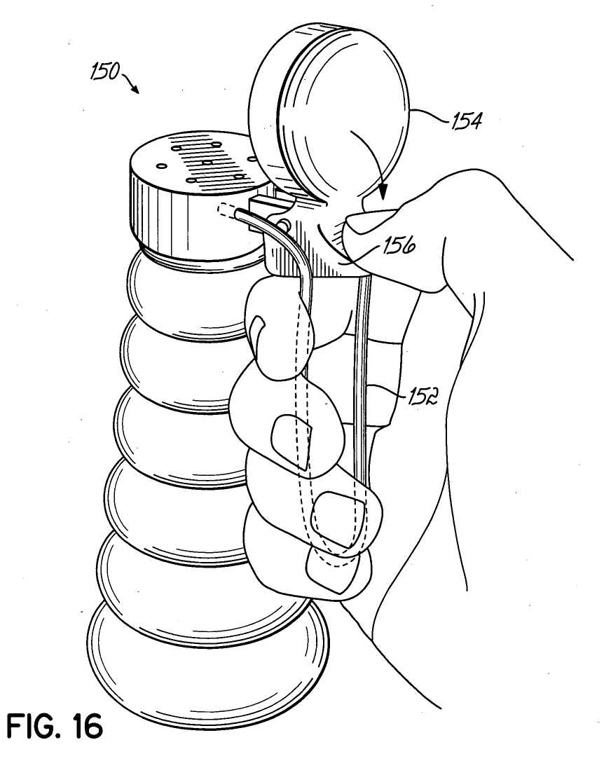

FIGS. 15 and 16 show a condiment shaker 150 that includes a grip handle 152 in addition to a flip top lid 154. A lever portion 156 of the lid 154 may be manipulated by a user's thumb as that user pulls the shaker using the grip handle 152 with the same hand of that thumb. Such a feature may provide further convenience for dispensing condiments.

While the present invention has been illustrated by a description of various embodiments and while these embodiments have been described in considerable detail in order to describe a mode of practicing the invention, it is not the intention of Applicant to restrict or in any way limit the scope of the appended claims to such detail. For instance, features of the inner container provide a sort of universal insert that may be packaged, used and/or sold with universal sleeves configured to accept the inner container. Users may thus use the same inner container with different outer containers of different designs and colors, e.g., outer containers associated with different seasons, sports teams or caricatures. While the embodiments are described above in the context of condiment dispensing, one skilled in the art will appreciate that the principles of the present invention may apply to other materials. For instance, the features of the present invention may apply equally to dispensing material that includes liquids and powders, e.g., pancake syrup and baby powder. Additional advantages and modifications within the spirit and scope of the invention will readily appear to those skilled in the art.

What is claimed is:

1. An apparatus for dispensing a material, comprising:
an outer container; and
an inner container configured to hold the material, wherein at least a portion of the inner container is configured to fit within the outer container and the inner container includes an opening configured to allow the through-flow of the material while at least the portion of the inner container is within the outer container.

2. The apparatus of claim 1, wherein the inner container further includes a base configured to stabilize the outer container when the inner container is positioned within the outer container.

3. The apparatus of claim 2, wherein the outer container further includes an aperture configured to allow the through-flow of the material from the opening of the inner container, and wherein the inner container is positioned inside the outer container through a second aperture in the outer container.

4. The apparatus of claim 2, wherein the inner container is configured to screw into mating threads positioned along an inside surface of the outer container.

5. The apparatus of claim 2, wherein the inner container is configured to snap into the outer container.

6. The apparatus of claim 2, wherein the inner container and the base cooperate to stabilize the outer container.

7. The apparatus of claim 1, wherein the outer container further includes an aperture configured to allow the through-flow of the material from the opening of the inner container.

8. The apparatus of claim 1, wherein the inner container is manufactured in connective relationship to a second inner container prior to use.

9. The apparatus of claim 1, further comprising a flip top lid biased towards a top surface of the outer container, the lid including a projection positioned on an underside surface of the flip top lid and configured to travel through an aperture in the outer container top.

10. The apparatus of claim 1, wherein the inner container further comprises an extension that extends out from a length of the inner container and rests on a mating surface of the outer container.

11. The apparatus of claim 1, wherein the inner container further includes a breakable seal that is broken to form the opening in the inner container.

12. The apparatus of claim 11, wherein a lid attached to at least one of the inner and outer container is configured to break the seal to form the opening.

13. The apparatus of claim 1, wherein the inner container is configured to be replaced and the outer container is configured to be reused.

14. The apparatus of claim 1, wherein the outer container includes circuitry configured to operate at least one of a light, a speaker and an automated moveable part.

15. An apparatus for dispensing a material comprising:
a hollow container configured to hold material;
a container top located proximate a top portion of the container and including a top surface having an opening configured to allow the through-flow of the material; and
a flip top lid biased towards the top surface of the container, the lid including a projection positioned on an underside surface of the flip top lid and configured to travel through the opening in the container top.

16. The apparatus of claim 15, further comprising a grip handle attached to the container and configured to allow a user to hold the grip handle with a hand and to operate the flip top lid using a thumb the hand.

17. The apparatus of claim 15, wherein the container top is configured to slide over the top portion of the container.

18. The apparatus of claim 15, wherein the container to is manufactured integrally with the container.

19. An apparatus for dispensing condiment material comprising:
a hollow container configured to hold and dispense condiment material; and
a prong configured to mechanically rotate about an axis within the hollow container to agitate the material.

20. The apparatus of claim 19, further comprising a gear in communication with the prong and configured to cause the prong to rotate in response to at least one of manual or automatic manipulation of the gear.
